(19) United States
(12) Patent Application Publication
(10) Pub. No.: US 2025/0230081 A1
(43) Pub. Date: Jul. 17, 2025

(54) SEWAGE TREATMENT DEVICE AND METHOD

(71) Applicant: SINGAPORE EBANG PTE, LTD., Singapore (SG)

(72) Inventor: Dong HU, Singapore (SG)

(21) Appl. No.: 18/679,502

(22) Filed: May 31, 2024

(30) Foreign Application Priority Data
Jan. 11, 2024 (CN) 202410040447.5

(51) Int. Cl. C02F 9/00; C02F 1/00; C02F 1/24; C02F 1/28; C02F 1/52; C02F 1/56; C02F 3/20; C02F 3/28; C02F 101/30

(52) U.S. Cl. CPC C02F 9/00; C02F 1/004; C02F 1/24; C02F 1/281; C02F 1/283; C02F 1/5245; C02F 1/56; C02F 3/20; C02F 3/2806; C02F 2101/30; C02F 2201/005; C02F 2209/40

(57) ABSTRACT

The present invention relates to the technical field of wastewater treatment, and specifically, to a wastewater treatment device and method, comprising the following steps: step 1: injecting wastewater into a flocculation scum treatment tank through a wastewater inlet; step 2: injecting an appropriate amount of composite aluminum salts and polyacrylic agents into the flocculation scum treatment tank through a metering pump to perform coagulation assistance and flocculation enhancement treatment; and starting an air pump to inject air into the flocculation scum treatment tank through an aeration pipe, forming tiny bubbles, whereby due to the flocculation effect of the flocculant, originally fine matters in the wastewater agglomerate into larger particles, forming suspended matters, and these suspended particles adhere on the bubbles and rise up to the water surface for the convenience of being processed by a foam pushing plate.

### TECHNICAL FIELD

The present invention relates to the technical field of wastewater treatment, and specifically, to a sewage treatment device and method.

### BACKGROUND OF THE INVENTION

Production line systems for photovoltaic cells and semiconductors consist of a power system, a special gas transmission system, a liquid transmission system, a clean air transmission system, an environmental protection treatment system, etc. Due to the complexity of the system composition, installation and maintenance are difficult. The above-mentioned installation and maintenance difficulties can be effectively solved by means of modular design and early factory prefabrication.

Dilute acid wastewater and dilute alkali wastewater are collected into a regulating tank. After homogenization and equalization, they are lifted to a pH regulating tank by a lifting pump. After two-stage pH regulation, the wastewater enters into an intermediate water tank, in which the wastewater is lifted to a self-cleaning filter by a lifting pump of the intermediate water tank and then enters into an ultrafiltration system. After the ultrafiltration device removes large particle matters, colloids, etc. from the wastewater, the wastewater enters into a reverse osmosis system for desalination. The reverse osmosis device can remove most of fluoride ions and inorganic salts, and produce product water which is supplied to a factory area as reuse water, and concentrate water which enters into a concentrated acid wastewater regulation tank and is subjected to subsequent physical and chemical treatment together with concentrated acid wastewater, and then is discharged outward after meeting the standard.

### SUMMARY OF THE INVENTION

The purpose of the present invention is to provide a sewage treatment device and method to solve the problems proposed in the above background of the invention.

In order to achieve the above purpose, the present invention provides the following technical solution: a sewage treatment method, comprising the following steps:
Step 1: injecting wastewater into a flocculation scum treatment tank through a wastewater inlet;
Step 2: injecting an appropriate amount of composite aluminum salts and polyacrylic agents into the flocculation scum treatment tank through a metering pump to perform coagulation assistance and flocculation enhancement treatment;
Step 3: injecting air into the flocculation scum treatment tank through an aeration pipe to form tiny bubbles, wherein due to a flocculation effect of the flocculants, originally fine matters in the wastewater agglomerate into larger particles, forming suspended matters; these suspended particles adhere on the bubbles and rise up to the water surface; and the scum is pushed by a foam pushing plate into a foam discharge port to discharge for collection so as to facilitate centralized treatment;
Step 4: introducing the wastewater in the flocculation scum treatment tank into a first organics decomposition tank, wherein by placing a semi-soft filler in the first organics decomposition tank, under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe to continuously supply oxygen to the wastewater through the aeration pipe; and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly;
Step 5: introducing the wastewater in the first organics decomposition tank into a second organics decomposition tank, wherein the wastewater treated in the previous section enters into the second organics decomposition tank, which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank to become easily degradable chain molecular organics under these conditions; and after entering into an upper aerobic layer, with a blower continuously sending air, another portion of the organics in the wastewater is consumed under the action of an aerobic biofilm, further reducing COD and BOD; and
Step 6: introducing the wastewater in the second organics decomposition tank into an adsorption filtration tank, wherein the wastewater comes out of the second organics decomposition tank with the sludge being formed in the second organics decomposition tank; since pollutants in the water are transformed into the sludge, the wastewater reaches the discharge standard after being filtered by the adsorption filtration tank and can be discharged into a sewer; and a filter material composition of the adsorption filtration tank is a filter material that can adopt a combination of activated anthracite and quartz sand, biochar and quartz sand, quartz sand and fiber filters or the like.

A sewage treatment device comprises a wastewater treatment tank, wherein a flocculation scum treatment tank is provided in the wastewater treatment tank at one end of near the front; a first organics decomposition tank is provided in the wastewater treatment tank at the back of the flocculation scum treatment tank; a second organics decomposition tank is provided in the wastewater treatment tank at the back of the first organics decomposition tank; an adsorption filtration tank is provided in the wastewater treatment tank at the back of the second organics decomposition tank; connection ports for wastewater overflow are provided between the adsorption filtration tank, the second organics decomposition tank, the first organics decomposition tank and the flocculation scum treatment tank; and valves for controlling the flow of the wastewater are fixedly installed inside the connection ports.

The further improvement of the technical solution of the present invention lies in: a wastewater inlet is installed on the front outer wall of the wastewater treatment tank close to the top of the front of the flocculation scum treatment tank; and a metering pump for injecting the composite aluminum salts and polyacrylic agents into the flocculation scum treatment tank for coagulation assistance and flocculation enhancement treatment is fixedly installed on the top of the wastewater treatment tank at the front of the flocculation scum treatment tank.

When the above technical solution is adopted, the wastewater is injected into the flocculation scum treatment tank through the wastewater inlet, and an appropriate amount of composite aluminum salts and polyacrylic agents are injected into the flocculation scum treatment tank through a metering pump for coagulation assistance and flocculation enhancement treatment.

The further improvement of the technical solution of the present invention lies in: foam discharge ports for discharging the scum are provided in both sides of the flocculation scum treatment tank near the back; and collection components for collecting the scum are fixedly installed on both sides of the wastewater treatment tank at the foam discharge ports.

The further improvement of the technical solution of the present invention lies in: the collection component is composed of a collection frame, a drawer trough, a drawer box and a filter plate, wherein the drawer trough is provided on the front of the collection frame; the drawer box is slidably connected to the inner wall of the drawer trough in a pull-out opening and closing manner, and when closed, the connection of the drawer trough is in a sealed state; and the filter plate is fixedly connected to a side of the drawer box near the foam discharge port.

When the above technical solution is adopted, it is convenient to collect the scum and remove the drawer box for centralized treatment of the scum in the later stage by means of slidably connecting the inner wall of the drawer trough within the collection frame with the drawer box, and the filter plate can filter the scum and discharge the water body.

The further improvement of the technical solution of the present invention lies in: support plates are fixedly connected to the top of the wastewater treatment tank on both sides of the back of the flocculation scum treatment tank; a bi-directional threaded rod is connected between the two support plates through bearing rotation; threaded blocks are in thread connection with the outer wall of the bi-directional threaded rod on both sides, and the threaded blocks are slidably connected to the top of the wastewater treatment tank; a driving motor for driving the bi-directional threaded rod to rotate is fixedly installed on a side of the right support plate on the top of the wastewater treatment tank; and foam pushing plates for pushing the scum into the collection components are fixedly connected to the bottom of the two threaded blocks, respectively.

When the above technical solution is adopted, the driving motor is started to drive the rotation of the bi-directional threaded rod, and the relative position limit is achieved through the connection relationship between the threaded blocks and the wastewater treatment tank, so that two threaded blocks drive the foam pushing plate to push the scum into the drawer box through the foam discharge port for collection.

The further improvement of the technical solution of the present invention lies in: an air pump is fixedly installed on the outer wall of the wastewater treatment tank at the right side of the flocculation scum treatment tank; and an aeration pipe for forming small bubbles to adsorb the suspended matters formed by the flocculation effect of the flocculant in the wastewater and carry them up to the water surface is fixedly connected to the bottom of the flocculation scum treatment tank.

When the above technical solution is adopted, the air pump is started to inject air into the flocculation scum treatment tank through the aeration pipe, forming tiny bubbles; and due to the flocculation effect of the flocculant, the originally fine matters in the wastewater agglomerate into larger particles, forming suspended matters, and these suspended particles adhere on the bubbles and rise up to the water surface for the convenience of being processed by the foam pushing plate.

The further improvement of the technical solution of the present invention lies in: the aeration pipe is composed of a connection pipe, branch gas pipes and air stones, wherein the connection pipe is fixedly connected to and communicated with an output end of the air pump; a row of the branch gas pipes are uniformly spread and fixedly connected to and communicated with an outer wall of the connection pipe; and an array of the air stones are uniformly arranged on the row of the branch gas pipes, and the air stones are fixedly connected to and communicated with the top of the branch gas pipes.

When the above technical solution is adopted, the gas stones are uniformly placed at the top of the row of the branch gas pipes, resulting in a large number of bubbles being generated uniformly in the tank with a high coverage.

The further improvement of the technical solution of the present invention lies in: an air pump is fixedly installed on the outer wall of the wastewater treatment tank at the right side of the first organics decomposition tank; an aeration pipe for oxygen aeration to improve the decomposition efficiency of aerobic bacteria is fixedly connected to the bottom of the first organics decomposition tank; an air pump is fixedly installed on the outer wall of the wastewater treatment tank at the right side of the second organics decomposition tank; an aeration pipe for oxygen aeration to improve the decomposition efficiency of aerobic bacteria is fixedly connected to the bottom of the second organics decomposition tank; filter material boxes for holding porous fillers are placed on the two inner wall of the second organics decomposition tank; and the filter material boxes are hung on the top of the wastewater treatment tank by means of hooks.

When the above technical solution is adopted, the wastewater in the flocculation scum treatment tank is introduced into the first organics decomposition tank, wherein by placing a semi-soft filler in the first organics decomposition tank, under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe to continuously supply oxygen to the wastewater through the aeration pipe; and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly The wastewater in the first organics decomposition tank is then introduced into a second organics decomposition tank, wherein the wastewater treated in the previous section enters into the second organics decomposition tank, which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank to become easily degradable chain molecular organics under these conditions; and after entering into an upper aerobic layer, with a blower continuously sending air, another portion of the organics in the wastewater is consumed under the action of an aerobic biofilm, further reducing COD and BOD.

The further improvement of the technical solution of the present invention lies in: a support frame for holding filter materials is placed on the inner wall of the adsorption filtration tank; four top corners of the support frame are fixedly connected to support blocks for supporting the support frame, respectively; a row of vertical bar partitions for water circulation is fixedly connected to the inner wall of the support frame; a row of overflow ports are provided on the top of the wastewater treatment tank at the adsorption filtration tank; a confluence frame is fixedly connected to the back outer wall of the wastewater treatment tank at the overflow ports; and a drainage outlet for discharging qualified water bodies is provided on the back of the confluence frame.

When the above technical solution is adopted, the wastewater in the second organics decomposition tank is introduced into the adsorption filtration tank, wherein the wastewater comes out of the second organics decomposition tank with the sludge being formed in the second organics decomposition tank; since pollutants in the water are transformed into the sludge, the wastewater reaches the discharge standard after being filtered by the adsorption filter materials in the support frame with the adsorption filtration tank, overflows through the overflow port and discharged through the drainage port and can be discharged into a sewer.

Compared with the prior art, the beneficial effects of the present invention are:
1. The present invention provides a sewage treatment device and method, in which the wastewater is injected into the flocculation scum treatment tank through the wastewater inlet, and an appropriate amount of composite aluminum salts and polyacrylic agents are injected into the flocculation scum treatment tank through a metering pump for coagulation assistance and flocculation enhancement treatment; the air pump is started to inject air into the flocculation scum treatment tank through the aeration pipe, forming tiny bubbles; due to the flocculation effect of the flocculant, the originally fine matters in the wastewater agglomerate into larger particles, forming suspended matters, and these suspended particles adhere on the bubbles and rise up to the water surface for the convenience of being processed by the foam pushing plate; the driving motor is started to drive the rotation of the bi-directional threaded rod; the relative position limit is achieved through the connection relationship between the threaded blocks and the wastewater treatment tank, so that the two threaded blocks drive the foam pushing plate to push the scum into the drawer box through the foam discharge port for collection.
2. The present invention provides a sewage treatment device and method, in which the wastewater in the flocculation scum treatment tank is introduced into the first organics decomposition tank, wherein by placing a semi-soft filler in the first organics decomposition tank, under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe to continuously supply oxygen to the wastewater through the aeration pipe; and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly; and the wastewater in the first organics decomposition tank is then introduced into a second organics decomposition tank, wherein the wastewater treated in the previous section enters into the second organics decomposition tank, which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank to become easily degradable chain molecular organics under these conditions; and after entering into an upper aerobic layer, with a blower continuously sending air, another portion of the organics in the wastewater is consumed under the action of an aerobic biofilm, further reducing COD and BOD.
3. The present invention provides a sewage treatment device and method, in which the wastewater in the second organics decomposition tank is introduced into the adsorption filtration tank, wherein the wastewater comes out of the second organics decomposition tank with the sludge being formed in the second organics decomposition tank; since pollutants in the water are transformed into the sludge, the wastewater reaches the discharge standard after being filtered by the adsorption filter materials in the support frame with the adsorption filtration tank, overflows through the overflow port and discharged through the drainage port and can be discharged into a sewer.

### BRIEF DESCRIPTION OF THE DRAWINGS

FIG. 1 is a schematic diagram of the overall structure of the present invention;

FIG. 2 is a top view of the present invention;

FIG. 3 is an enlarged view of A in the present invention;

FIG. 4 is a schematic diagram of the structure of the collection component in the present invention;

FIG. 5 is a schematic diagram of the structure of the aeration pipe in the present invention;

FIG. 6 is a schematic diagram of the structure of the filter material box in the present invention; and

FIG. 7 is a schematic diagram of the structure of the support frame in the present invention.

In the figures: 1. Wastewater treatment tank; 11. Connection port; 2. Flocculation scum treatment tank; 21. Wastewater inlet; 22. Metering pump; 23. Foam discharge port; 24. Collection component; 241. Collection frame; 242. Drawer trough; 243. Drawer box; 244. Filter plate; 25. Support plate; 26. Bi-directional threaded rod; 27. Threaded block; 28. Driving motor; 29. Foam pushing plate; 3. First organics decomposition tank; 4. Second organics decomposition tank; 41. Filter material box; 42. Hook; 5. Adsorption filtration tank; 51. Support frame; 511. Support block; 512. Vertical bar partition; 52. Overflow port; 53. Confluence frame; 531. Drainage outlet; 6. Air pump; 61. Aeration pipe; 611. Connection pipe; 612. Branch gas pipe; and 613. Gas stone.

### DETAILED DESCRIPTION OF THE INVENTION

A clear and complete description of the technical solution in the embodiments of the present invention will be provided as below according to the accompanying drawings of embodiments of the present invention. Obviously, the described embodiments are only a part, not all, of the embodiments of the present invention. Based on the embodiments in the present invention, all other embodiments obtained by those of ordinary skill in the art without creative effort shall fall within the scope of protection of the present invention.

In the prior art, a large amount of wastewater is generated during the processing of tire rubber, and the wastewater contains a large amount of solid impurities. If the wastewater is directly discharged without purification, they not only easily block the internal transportation pipeline but also affect the environment. At the same time, when the wastewater is directly treated without removal of solid impurities, the solid impurities in the wastewater will impact the effect of wastewater treatment, which is adverse to the reuse treatment of wastewater. Synthetic rubber, as one of the three major synthetic materials, has a wide range of uses, but the wastewater generated during its production process is difficult to treat.

The technical problems discovered by the inventors are as follows. At present, the treatment methods for wastewater from synthetic rubber production mainly include the coagulation sedimentation method, the coagulation gas flotation method, the electrochemical method, the biological method, as well as the advanced oxidation method, the adsorption method, and the reverse osmosis method used for deep treatment. Due to different treatment requirements and objectives, the treatment methods used are also different. A single treatment method often cannot meet the treatment requirements, and the existing treatment process for synthetic rubber wastewater can hardly reduce the COD concentration to below 60 mg/L to meet the increasingly strict requirements for discharge up to standard.

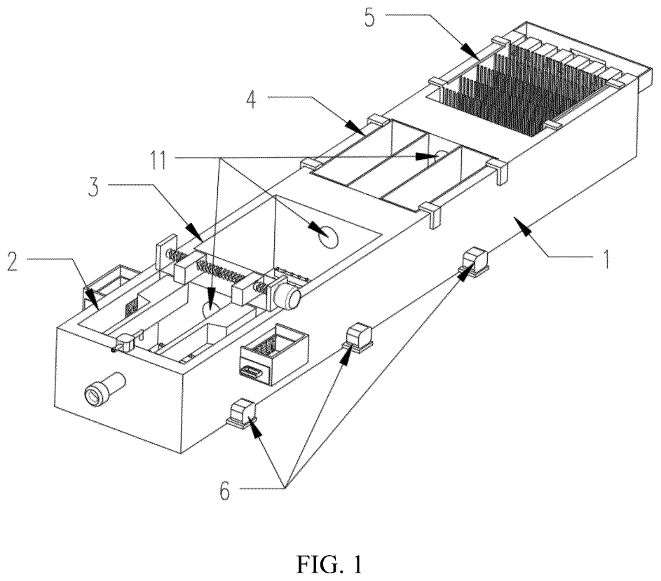

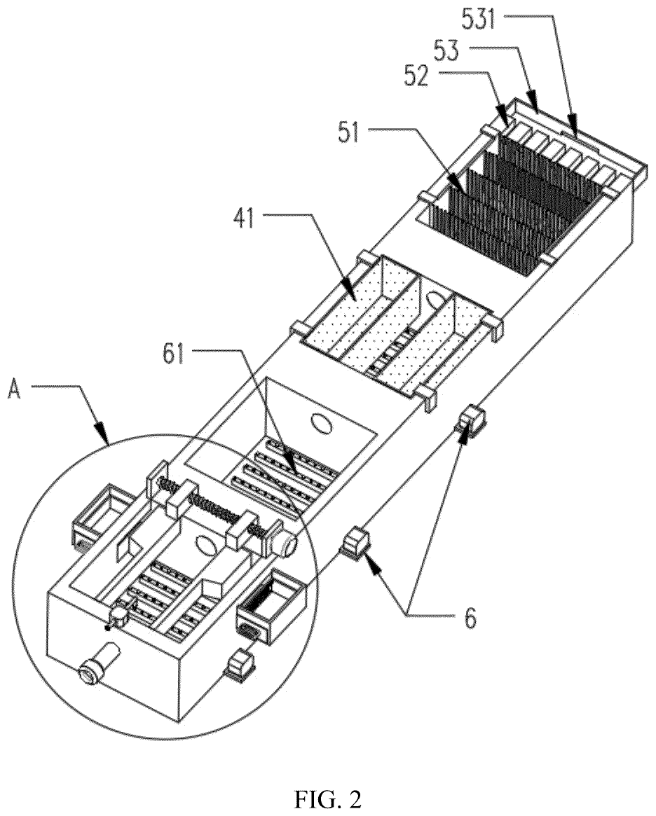

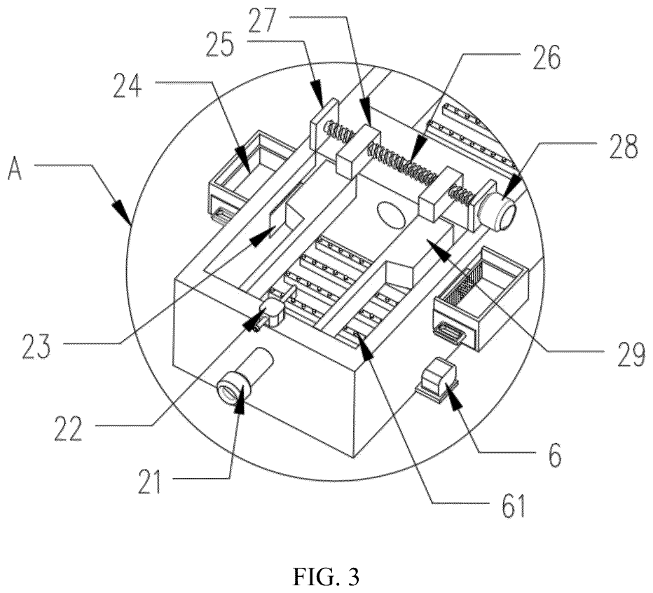

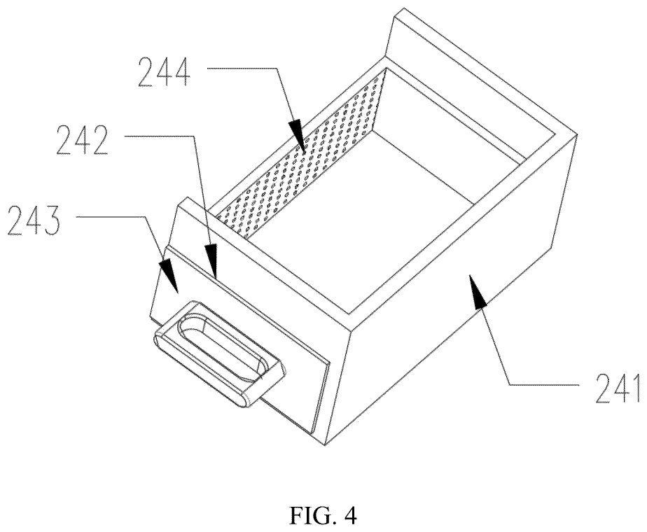

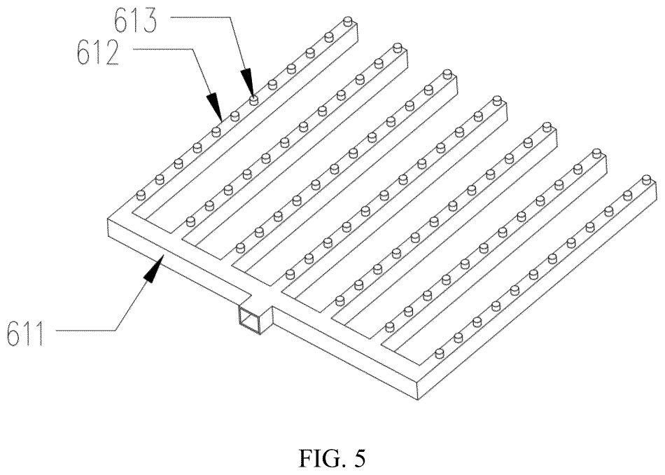

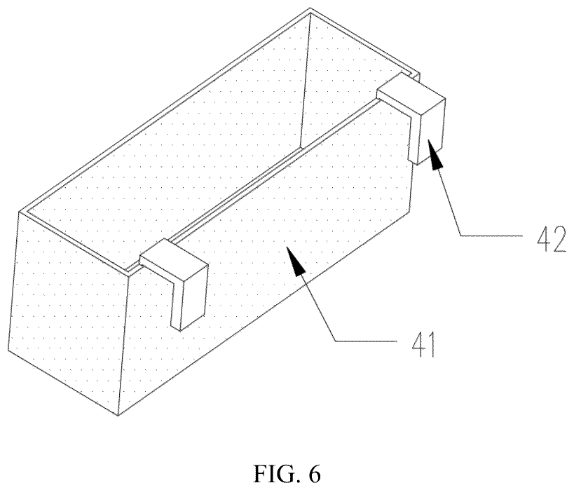

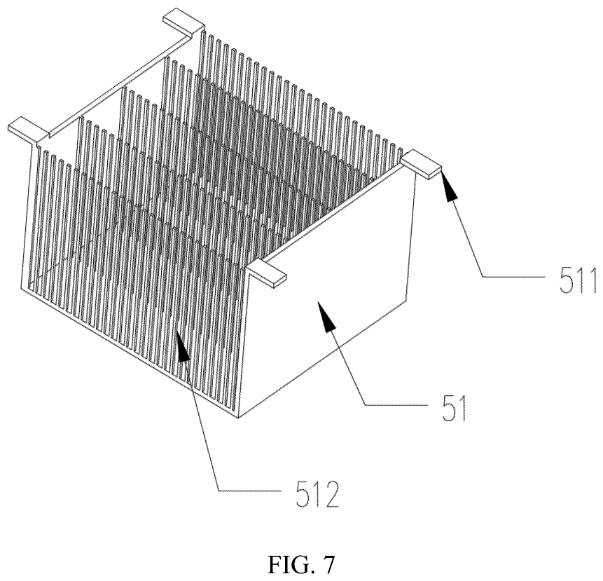

A sewage treatment method as shown in FIGS. 1-7 comprises the following steps:
Step 1: injecting wastewater into a flocculation scum treatment tank 2 through a wastewater inlet 21;
Step 2: injecting an appropriate amount of composite aluminum salts and polyacrylic agents into the flocculation scum treatment tank 2 through a metering pump 22 to perform coagulation assistance and flocculation enhancement treatment;
Step 3: injecting air into the flocculation scum treatment tank 2 through an aeration pipe 61 to form tiny bubbles, wherein due to a flocculation effect of the flocculants, originally fine matters in the wastewater agglomerate into larger particles, forming suspended matters; these suspended particles adhere on the bubbles and rise up to the water surface; and the scum is pushed by a foam pushing plate 29 into a foam discharge port 23 to discharge for collection so as to facilitate centralized treatment;
Step 4: introducing the wastewater in the flocculation scum treatment tank 2 into a first organics decomposition tank 3, wherein by placing a semi-soft filler in the first organics decomposition tank 3, under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe 61 to continuously supply oxygen to the wastewater through the aeration pipe 61; and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly;
Step 5: introducing the wastewater in the first organics decomposition tank 3 into a second organics decomposition tank 4, wherein the wastewater treated in the previous section enters into the second organics decomposition tank 4, which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank 3 to become easily degradable chain molecular organics under these conditions; and after entering into an upper aerobic layer, with a blower continuously sending air, another portion of the organics in the wastewater is consumed under the action of an aerobic biofilm, further reducing COD and BOD; and
Step 6: introducing the wastewater in the second organics decomposition tank 4 into an adsorption filtration tank 5, wherein the wastewater comes out of the second organics decomposition tank 4 with the sludge being formed in the second organics decomposition tank 4; since pollutants in the water are transformed into the sludge, the wastewater reaches the discharge standard after being filtered by the adsorption filtration tank 5 and can be discharged into a sewer; and a filter material composition of the adsorption filtration tank 5 is a filter material that can adopt a combination of activated anthracite and quartz sand, biochar and quartz sand, quartz sand and fiber filters or the like.

A sewage treatment device as shown in FIGS. 1-7 comprises a wastewater treatment tank 1, wherein a flocculation scum treatment tank 2 is provided in the wastewater treatment tank 1 at one end of near the front; a first organics decomposition tank 3 is provided in the wastewater treatment tank 1 at the back of the flocculation scum treatment tank 2; a second organics decomposition tank 4 is provided in the wastewater treatment tank 1 at the back of the first organics decomposition tank 3; an adsorption filtration tank 5 is provided in the wastewater treatment tank 1 at the back of the second organics decomposition tank 4; connection ports 11 for wastewater overflow are provided between the adsorption filtration tank 5, the second organics decomposition tank 4, the first organics decomposition tank 3 and the flocculation scum treatment tank 2; and valves for controlling the flow of the wastewater are fixedly installed inside the connection ports 11. A wastewater inlet 21 is installed on the front outer wall of the wastewater treatment tank 1 close to the top of the front of the flocculation scum treatment tank 2; and a metering pump 22 for injecting the composite aluminum salts and polyacrylic agents into the flocculation scum treatment tank 2 for coagulation assistance and flocculation enhancement treatment is fixedly installed on the top of the wastewater treatment tank 1 at the front of the flocculation scum treatment tank 2. In this solution, the wastewater is injected into the flocculation scum treatment tank 2 through the wastewater inlet 21, and an appropriate amount of composite aluminum salts and polyacrylic agents are injected into the flocculation scum treatment tank 2 through a metering pump 22 for coagulation assistance and flocculation enhancement treatment. Foam discharge ports 23 for discharging the scum are provided in both sides of the flocculation scum treatment tank 2 near the back; and collection components 24 for collecting the scum are fixedly installed on both sides of the wastewater treatment tank 1 at the foam discharge ports 23. The collection component 24 is composed of a collection frame 241, a drawer trough 242, a drawer box 243 and a filter plate 244, wherein the drawer trough 242 is provided on the front of the collection frame 241; the drawer box 243 is slidably connected to the inner wall of the drawer trough 242 in a pull-out opening and closing manner, and when closed, the connection of the drawer trough 242 is in a sealed state; and the filter plate 244 is fixedly connected to a side of the drawer box 243 near the foam discharge port 23. In this solution, it is convenient to collect the scum and remove the drawer box 243 for centralized treatment of the scum in the later stage by means of slidably connecting the inner wall of the drawer trough 242 within the collection frame 241 with the drawer box 243, and the filter plate 244 can filter the scum and discharge the water body. Support plates 25 are fixedly connected to the top of the wastewater treatment tank 1 on both sides of the back of the flocculation scum treatment tank 2; a bi-directional threaded rod 26 is connected between the two support plates 25 through bearing rotation; threaded blocks 27 are in thread connection with the outer wall of the bi-directional threaded rod 26 on both sides, and the threaded blocks 27 are slidably connected to the top of the wastewater treatment tank 1; a driving motor 28 for driving the bi-directional threaded rod 26 to rotate is fixedly installed on a side of the right support plate 25 on the top of the wastewater treatment tank 1; and foam pushing plates 29 for pushing the scum into the collection components 24 are fixedly connected to the bottom of the two threaded blocks 26, respectively. In this solution, the driving motor 28 is started to drive the rotation of the bi-directional threaded rod 26, and the relative position limit is achieved through the connection relationship between the threaded blocks 27 and the wastewater treatment tank 1, so that two threaded blocks 27 drive the foam pushing plate 29 to push the scum into the drawer box 243 through the foam discharge port 23 for collection. In this solution, the air pump 6 is fixedly installed on the outer wall of the wastewater treatment tank 1 at the right side of the flocculation scum treatment tank 2; and an aeration pipe 61 for forming small bubbles to adsorb the suspended matters formed by the flocculation effect of the flocculant in the wastewater and carry them up to the water surface is fixedly connected to the bottom of the flocculation scum treatment tank 2. The air pump 6 is started to inject air into the flocculation scum treatment tank 2 through the aeration pipe 61, forming tiny bubbles; and due to the flocculation effect of the flocculant, the originally fine matters in the wastewater agglomerate into larger particles, forming suspended matters, and these suspended particles adhere on the bubbles and rise up to the water surface for the convenience of being processed by the foam pushing plate. The aeration pipe 61 is composed of a connection pipe 611, branch gas pipes 612 and air stones 613, wherein the connection pipe 611 is fixedly connected to and communicated with an output end of the air pump 6; a row of the branch gas pipes 612 are uniformly spread and fixedly connected to and communicated with an outer wall of the connection pipe 611; and an array of the air stones 613 are uniformly arranged on the row of the branch gas pipes 612, and the air stones 613 are fixedly connected to and communicated with the top of the branch gas pipes 612. In this solution, the gas stones 613 are uniformly placed at the top of the row of the branch gas pipes 612, resulting in a large number of bubbles being generated uniformly in the tank with a high coverage.

In this embodiment, the wastewater is injected into the flocculation scum treatment tank 2 through the wastewater inlet 21, and an appropriate amount of composite aluminum salts and polyacrylic agents are injected into the flocculation scum treatment tank 2 through a metering pump 22 for coagulation assistance and flocculation enhancement treatment; the air pump 6 is started to inject air into the flocculation scum treatment tank 2 through the aeration pipe 61, forming tiny bubbles; due to the flocculation effect of the flocculant, the originally fine matters in the wastewater agglomerate into larger particles, forming suspended matters, and these suspended particles adhere on the bubbles and rise up to the water surface for the convenience of being processed by the foam pushing plate 29; the driving motor 28 is started to drive the rotation of the bi-directional threaded rod 26; the relative position limit is achieved through the connection relationship between the threaded blocks 27 and the wastewater treatment tank 1, so that the two threaded blocks 27 drive the foam pushing plate 29 to push the scum into the drawer box 243 through the foam discharge port 23 for collection.

As shown in FIGS. 1-7, an air pump 6 is fixedly installed on the outer wall of the wastewater treatment tank 1 at the right side of the first organics decomposition tank 3; an aeration pipe 61 for oxygen aeration to improve the decomposition efficiency of aerobic bacteria is fixedly connected to the bottom of the first organics decomposition tank 3; an air pump 6 is fixedly installed on the outer wall of the wastewater treatment tank 1 at the right side of the second organics decomposition tank 4; an aeration pipe 61 for oxygen aeration to improve the decomposition efficiency of aerobic bacteria is fixedly connected to the bottom of the second organics decomposition tank 4; filter material boxes 41 for holding porous fillers are placed on the two inner wall of the second organics decomposition tank 4; and the filter material boxes 41 are hung on the top of the wastewater treatment tank 1 by means of hooks 42.

In this embodiment, the wastewater in the flocculation scum treatment tank 2 is introduced into the first organics decomposition tank 3, wherein by placing a semi-soft filler in the first organics decomposition tank 3, under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe 61 to continuously supply oxygen to the wastewater through the aeration pipe 61; and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly The wastewater in the first organics decomposition tank 3 is then introduced into a second organics decomposition tank 4, wherein the wastewater treated in the previous section enters into the second organics decomposition tank 4, which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank 3 to become easily degradable chain molecular organics under these conditions; and after entering into an upper aerobic layer, with a blower continuously sending air, another portion of the organics in the wastewater is consumed under the action of an aerobic biofilm, further reducing COD and BOD.

As shown in FIGS. 1-7, a support frame 51 for holding filter materials is placed on the inner wall of the adsorption filtration tank 5; four top corners of the support frame 51 are fixedly connected to support blocks 511 for supporting the support frame 51; a row of vertical bar partitions 512 for water circulation is fixedly connected to the inner wall of the support frame 51, respectively; a row of overflow ports 52 are provided on the top of the wastewater treatment tank 1 at the adsorption filtration tank 5; a confluence frame 53 is fixedly connected to the back outer wall of the wastewater treatment tank 1 at the overflow ports 52; and a drainage outlet 531 for discharging qualified water bodies is provided on the back of the confluence frame 53.

In this embodiment, the wastewater in the second organics decomposition tank 4 is introduced into the adsorption filtration tank 5, wherein the wastewater comes out of the second organics decomposition tank 4 with the sludge being formed in the second organics decomposition tank 4; since pollutants in the water are transformed into the sludge, the wastewater reaches the discharge standard after being filtered by the adsorption filter materials in the support frame 51 with the adsorption filtration tank 5, overflows through the overflow port 52 and discharged through the drainage port 531 and can be discharged into a sewer.

The working principle of the present invention is as follows: the wastewater is injected into the flocculation scum treatment tank 2 through the wastewater inlet 21, and an appropriate amount of composite aluminum salts and polyacrylic agents are injected into the flocculation scum treatment tank 2 through a metering pump 22 for coagulation assistance and flocculation enhancement treatment; the air pump 6 is started to inject air into the flocculation scum treatment tank 2 through the aeration pipe 61, forming tiny bubbles; due to the flocculation effect of the flocculant, the originally fine matters in the wastewater agglomerate into larger particles, forming suspended matters, and these suspended particles adhere on the bubbles and rise up to the water surface for the convenience of being processed by the foam pushing plate 29; the driving motor 28 is started to drive the rotation of the bi-directional threaded rod 26; the relative position limit is achieved through the connection relationship between the threaded blocks 27 and the wastewater treatment tank 1, so that the two threaded blocks 27 drive the foam pushing plate 29 to push the scum into the drawer box 243 through the foam discharge port 23 for collection. The wastewater in the flocculation scum treatment tank 2 is introduced into the first organics decomposition tank 3, wherein by placing a semi-soft filler in the first organics decomposition tank 3, under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe 61 to continuously supply oxygen to the wastewater through the aeration pipe 61; and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly; and the wastewater in the first organics decomposition tank 3 is then introduced into a second organics decomposition tank 4, wherein the wastewater treated in the previous section enters into the second organics decomposition tank 4, which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank 3 to become easily degradable chain molecular organics under these conditions; and after entering into an upper aerobic layer, with a blower continuously sending air, another portion of the organics in the wastewater is consumed under the action of an aerobic biofilm, further reducing COD and BOD. The wastewater in the second organics decomposition tank 4 is introduced into the adsorption filtration tank 5, wherein the wastewater comes out of the second organics decomposition tank 4 with the sludge being formed in the second organics decomposition tank 4; since pollutants in the water are transformed into the sludge, the wastewater reaches the discharge standard after being filtered by the adsorption filter materials in the support frame 51 with the adsorption filtration tank 5, overflows through the overflow port 52 and discharged through the drainage port 531 and can be discharged into a sewer.

The basic principles, main features, and advantages of the present invention are shown and described as above. Those skilled in the art should understand that the present invention is not limited by the above-mentioned embodiments. Described in the above-mentioned embodiments and the specification are only preferred examples of the present invention that are not intended to limit the present invention. Various modifications and improvements can be made to the present invention without departing from the spirit and scope of the present invention, all of which fall within the claimed protection scope of the present invention. The scope of protection claimed by the present invention is defined by the accompanying claims and their equivalents.

1. A sewage treatment method, comprising the following steps:
step 1: injecting wastewater into a flocculation scum treatment tank (2) through a wastewater inlet (21);
step 2: injecting an appropriate amount of composite aluminum salts and polyacrylic agents into the flocculation scum treatment tank (2) through a metering pump (22) to perform coagulation assistance and flocculation enhancement treatment;
step 3: injecting air into the flocculation scum treatment tank (2) through an aeration pipe (61) to form tiny bubbles, wherein due to a flocculation effect of the flocculants, originally fine matters in the wastewater agglomerate into larger particles, forming suspended matters; these suspended particles adhere on the bubbles and rise up to the water surface; and the scum is pushed by a foam pushing plate (29) into a foam discharge port (23) to discharge for collection so as to facilitate centralized treatment;
step 4: introducing the wastewater in the flocculation scum treatment tank (2) into a first organics decomposition tank (3), wherein by placing a semi-soft filler in the first organics decomposition tank (3), under the action of anaerobic microorganisms on the surface of the filler, a portion of non-degradable ring molecular organics is transformed into easily biodegradable chain molecular organics, thereby increasing the BOD content in the wastewater; the wastewater is subjected to hydrolysis acidification for eight to sixteen hours and is then aerated by means of the aeration pipe (61) to continuously supply oxygen to the wastewater through the aeration pipe (61); and aerobic bacteria in activated sludge in the wastewater rapidly propagate after obtaining a large amount of oxygen and consume a large amount of the organics in the water, forming bacterial clusters to turn the organics into removable sludge, thereby reducing COD and BOD significantly;
step 5: introducing the wastewater in the first organics decomposition tank (3) into a second organics decomposition tank (4), wherein the wastewater treated in the previous section enters into the second organics decomposition tank (4), which is filled with solid porous fillers such as coke, steel slag, and pumice; in an anaerobic section at the bottom of the tank, since a layer of anaerobic microorganisms called a microbial film is attached to the surface of the solid fillers, the wastewater is subjected to hydrolysis acidification again under the action of the anaerobic bacteria, causing a portion of the ring molecular organics that are not opened in the first organics decomposition tank (3) to become easily degradable chain molecular organics under these conditions; and after entering into an upper aerobic layer, with a blower continuously sending air, another portion of the organics in the wastewater is consumed under the action of an aerobic biofilm, further reducing COD and BOD; and
step 6: introducing the wastewater in the second organics decomposition tank (4) into an adsorption filtration tank (5), wherein the wastewater comes out of the second organics decomposition tank (4) with the sludge being formed in the second organics decomposition tank (4); since pollutants in the water are transformed into the sludge, the wastewater reaches the discharge standard after being filtered by the adsorption filtration tank (5) and can be discharged into a sewer; and a filter material composition of the adsorption filtration tank (5) is a filter material 10 that can adopt a combination of activated anthracite and quartz sand, biochar and quartz sand, or quartz sand and fiber filters.

2. A sewage treatment device for carrying out the sewage treatment method of claim 1, comprising a wastewater treatment tank (1), wherein a flocculation scum treatment tank (2) is provided in the wastewater treatment tank (1) at one end of near the front; a first organics decomposition tank (3) is provided in the wastewater treatment tank (1) at the back of the flocculation scum treatment tank (2); a second organics decomposition tank (4) is provided in the wastewater treatment tank (1) at the back of the first organics decomposition tank (3); an adsorption filtration tank (5) is provided in the wastewater treatment tank (1) at the back of the second organics decomposition tank (4); connection ports (11) for wastewater overflow are provided between the adsorption filtration tank (5), the second organics decomposition tank (4), the first organics decomposition tank (3) and the flocculation scum treatment tank (2); and valves for controlling the flow of the wastewater are fixedly installed inside the connection ports (11).

3. The sewage treatment device according to claim 2, wherein a wastewater inlet (21) is installed on the front outer wall of the wastewater treatment tank (1) close to the top of the front of the flocculation scum treatment tank (2); and a metering pump (22) for injecting the composite aluminum salts and polyacrylic agents into the flocculation scum treatment tank (2) for coagulation assistance and flocculation enhancement treatment is fixedly installed on the top of the wastewater treatment tank (1) at the front of the flocculation scum treatment tank (2).

4. The sewage treatment device according to claim 2, wherein foam discharge ports (23) for discharging the scum are provided in both sides of the flocculation scum treatment tank (2) near the back; and collection components (24) for collecting the scum are fixedly installed on both sides of the wastewater treatment tank (1) at the foam discharge ports (23).

5. The sewage treatment device according to claim 4, wherein the collection component (24) is composed of a collection frame (241), a drawer trough (242), a drawer box (243) and a filter plate (244), wherein the drawer trough (242) is provided on the front of the collection frame (241); the drawer box (243) is slidably connected to the inner wall of the drawer trough (242) in a pull-out opening and closing manner, and when closed, the connection of the drawer trough (242) is in a sealed state; and the filter plate (244) is fixedly connected to a side of the drawer box (243) near the foam discharge port (23).

6. The sewage treatment device according to claim 5, wherein support plates (25) are fixedly connected to the top of the wastewater treatment tank (1) on both sides of the back of the flocculation scum treatment tank (2); a bi-directional threaded rod (26) is connected between the two support plates (25) through bearing rotation; threaded blocks (27) are in thread connection with the outer wall of the bi-directional threaded rod (26) on both sides, and the threaded blocks (27) are slidably connected to the top of the wastewater treatment tank (1); a driving motor (28) for driving the bi-directional threaded rod (26) to rotate is fixedly installed on a side of the right support plate (25) on the top of the wastewater treatment tank (1); and foam pushing plates (29) for pushing the scum into the collection components (24) are fixedly connected to the bottom of the two threaded blocks (27), respectively.

7. The sewage treatment device according to claim 2, wherein an air pump (6) is fixedly installed on the outer wall of the wastewater treatment tank (1) at the right side of the flocculation scum treatment tank (2); and an aeration pipe (61) for forming small bubbles to adsorb the suspended matters formed by the flocculation effect of the flocculant in the wastewater and carry them up to the water surface is fixedly connected to the bottom of the flocculation scum treatment tank (2).

8. The sewage treatment device according to claim 7, wherein the aeration pipe (61) is composed of a connection pipe (611), branch gas pipes (612) and air stones (613), wherein the connection pipe (611) is fixedly connected to and communicated with an output end of the air pump (6); a row of the branch gas pipes (612) are uniformly spread and fixedly connected to and communicated with an outer wall of the connection pipe (611); and an array of the air stones (613) are uniformly arranged on the row of the branch gas pipes (612), and the air stones (613) are fixedly connected to and communicated with the top of the branch gas pipes (612).

9. The sewage treatment device according to claim 2, wherein an air pump (6) is fixedly installed on the outer wall of the wastewater treatment tank (1) at the right side of the first organics decomposition tank (3); an aeration pipe (61) for oxygen aeration to improve the decomposition efficiency of aerobic bacteria is fixedly connected to the bottom of the first organics decomposition tank (3); an air pump (6) is fixedly installed on the outer wall of the wastewater treatment tank (1) at the right side of the second organics decomposition tank (4); an aeration pipe (61) for oxygen aeration to improve the decomposition efficiency of aerobic bacteria is fixedly connected to the bottom of the second organics decomposition tank (4); filter material boxes (41) for holding porous fillers are placed on the two inner wall of the second organics decomposition tank (4); and the filter material boxes (41) are hung on the top of the wastewater treatment tank (1) by means of hooks (42).

10. The sewage treatment device according to claim 2, wherein a support frame (51) for holding filter materials is placed on the inner wall of the adsorption filtration tank (5); four top corners of the support frame (51) are fixedly connected to support blocks (511) for supporting the support frame (51), respectively; a row of vertical bar partitions (512) for water circulation is fixedly connected to the inner wall of the support frame (51); a row of overflow ports (52) are provided on the top of the wastewater treatment tank (1) at the adsorption filtration tank (5); a confluence frame (53) is fixedly connected to the back outer wall of the wastewater treatment tank (1) at the overflow ports (52); and a drainage outlet (531) for discharging qualified water bodies is provided on the back of the confluence frame (53).
